(19) United States
(12) Patent Application Publication
(10) Pub. No.: US 2005/0080640 A1
(43) Pub. Date: Apr. 14, 2005

(54) System and method for generating a business process integration and management (BPIM) solution

(75) Inventors: Kumar Bhaskaran, Englewood Cliffs, NJ (US); Ying Huang, Yorktown Heights, NY (US); Shubir Kapoor, Mohegan Lake, NY (US); Santhosh Kumaran, Croton on Hudson, NY (US); Prabir Nandi, Bayside, NY (US); Zhong Tian, Beijing (CN); Jian Wang, Beijing (CN); Frederick Y. Wu, Cos Cob, CT (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/682,800

(22) Filed: Oct. 10, 2003

(51) Int. Cl. G06F 17/60

(52) U.S. Cl. 705/1

(57) ABSTRACT

A system for generating a business process integration and management (BPIM) solution includes an assembler which assembles a plurality of solution artifacts to form a platform-independent solution template, a template implementer which implements the platform-independent solution template to form a template implementation, and a customizer which customizes the template implementation to generate a BPIM solution.

### CROSS REFERENCE TO RELATED APPLICATIONS

This application is related to U.S. patent application Ser. No. ______ (Attorney docket No. YOR920030252US1) entitled “System and Method for Analyzing a Business Process Integration and Management (BPIM) Solution” which is commonly assigned with the present application, and is incorporated herein by reference.

### BACKGROUND OF THE INVENTION

1. Field of the Invention

The present invention relates to a system and method of generating a business process integration and management (BPIM) solution and, in particular, a system and method which utilizes a platform-independent solution template.

2. Description of the Related Art

With the advancement of information technology and business transformation, and to increase profits from its value chain, an enterprise has to be able to rapidly modify and adapt its business process and collaboration infrastructure. Business process Integration and Management (BPIM) is the key to building and managing an adaptive e-business solution infrastructure.

As an enabling technology of business process integration, Web (e.g., Internet) services provide a standardized means to allow heterogeneous applications to communicate with one another. However, existing e-business integration solutions are mostly custom-made by ground-up code development with many undesirable characteristics.

For example, such conventional methods are very labor intensive and very skill demanding. Further, such methods involve unstructured solution knowledge and are, therefore, sharable only at code level. In addition, the process is manually processed from business process modeling (BPM) to solution creation, and is not adaptable to updates and changes.

### SUMMARY OF THE INVENTION

In view of the foregoing and other exemplary problems, disadvantages, and drawbacks of the aforementioned systems and methods, it is an exemplary purpose of the present invention to provide a system and method involving a new and more efficient approach to generating (e.g., developing and deploying) Business Process Integration and Management (BPIM) solutions.

The present invention includes a system for generating a business process integration and management (BPIM) solution. The system includes an assembler which assembles a plurality of solution artifacts to form a platform-independent solution template, a template implementer which implements the platform-independent solution template to form a template implementation, and a customizer which customizes the template implementation to generate a BPIM solution.

Further, the assembler, the implementer and the customizer may be integrally formed and include a processor (e.g., a single processor or a plurality of processors).

The system may also include a decomposer which decomposes a BPIM solution into the plurality of solution artifacts, a composition of the plurality of solution artifacts, and a specified set of associated common services. The system may also include a memory device which stores, for example, the plurality of solution artifacts, and a computer network (e.g., the world wide web or Internet) for deploying the BPIM solution.

The system may also include a business process modeler (e.g., operatively coupled to the assembler) which generates a business process model, and an identifier which identifies an initial set of solution artifacts based on the business process model. The plurality of solution artifacts may include the initial set of solution artifacts.

In addition, in one aspect, the assembler may categorize the plurality of solution artifacts into categories including at least one of a business object category, connector/adapter/business-to-business connector category, adaptive entity category, flow category and view category.

Further, the plurality of solution artifacts may be assembled from at least one of new solution artifacts and an initial set of solution artifacts identified in a business process model. For example, the new solution artifacts may include solution artifacts which are stored in the memory device (e.g., asset library).

The system may also include a deployment apparatus (e.g., a computer network) for deploying the BPIM solution. For example, the BPIM solution may include an electronic commerce BPIM solution, and the computer network may include the world wide web (e.g., Internet).

Further, the platform-independent solution template may include a plurality of platform-independent solution templates. Further, the system may also include a database operatively coupled to the assembler for storing the plurality of platform-independent solution templates. The system may also include an input device (e.g., keyboard, mouse, etc.) operatively coupled (e.g., to the assembler or template implementer), for inputting a business process model. The template implementer may also map at least one of the plurality of platform-independent solution templates with the business process model to form the template implementation.

In addition, a solution artifact in the plurality of solution artifacts may include at least one interface description. The solution artifacts in the plurality of solution artifacts may be alterable to match a BPIM solution requirement.

Further, the platform-independent solution template may include at least one of an extensible mark-up language (XML) schema, and a unified modeling language (UML) profile. Further, the platform-independent solution template may include a modifiable and reusable template.

In addition, the template implementation may include platform specific information, prior usage, and existing code fragments to describe possible implementation details of a platform-independent solution template for one specific implementation (e.g., a platform-specific template implementation). Further, the plurality of solution artifacts may include standard-based interfaces.

For example, the realization of the template implementation may include one of a small/medium size business solution template, an insurance industry solution template, a life sciences industry solution template, a telecommunication industry solution template, and a personal computer manufacturing industry solution template.

Another aspect of the present invention includes a system for generating a business process integration and management (BPIM) solution. The system includes assembling means which assembles a plurality of solution artifacts to form a platform-independent solution template, template implementing means which implements the platform-independent solution template to form a template implementation, and customizing means which customizes the template implementation to generate a BPIM solution.

Another aspect of the present invention includes a method for generating a business process integration and management (BPIM) solution. The method includes assembling a plurality of solution artifacts (e.g., with associated common services) to form a platform-independent solution template, implementing the platform-independent solution template to form a template implementation, and customizing the template implementation to generate a BPIM solution. For example, assembling the plurality of solution artifacts may include at least one of retrieving artifacts from an asset library and creating new artifacts.

The method may also include modeling a business process to generate a business process model, and identifying an initial set of solution artifacts based on the business process model. The plurality of solution artifacts may include the initial set of solution artifacts. The method may also include decomposing a BPIM solution into a plurality of solution artifacts, and storing the plurality of solution artifacts in a memory device.

Further, decomposing the BPIM solution may include partitioning a BPIM solution space into components including at least one of a business object, connector/adapter/business-to-business connector, adaptive entity, flow and view. Furthermore, customizing the template implementation may include modifying the solution artifact to conform to a requirement of the BPIM solution.

The present invention also includes a programmable storage medium tangibly embodying a program of machine-readable instructions executable by a digital processing apparatus to perform the inventive method.

The present invention also includes a method for deploying computing infrastructure in which computer-readable code is integrated into a computing system, and combines with the computing system to perform the inventive method.

With its unique and novel features, the present invention provides a system and method of generating a business process integration and management (BPIM) solution which is significantly more efficient than conventional systems and methods.

### BRIEF DESCRIPTION OF THE DRAWINGS

The foregoing and other exemplary purposes, aspects and advantages will be better understood from the following detailed description of the exemplary embodiments of the invention with reference to the drawings, in which:

FIG. 1 illustrates an exemplary system 100 for generating a business process integration and management (BPIM) solution, in accordance with an exemplary aspect of the present invention;

FIG. 2 illustrates a development from business process modeling to solution template creation, in accordance with an exemplary aspect of the present invention;

FIG. 3 illustrates a solution assembly (e.g., development from a solution template to a BPIM Solution), in accordance with an exemplary aspect of the present invention;

FIG. 4A illustrates an exemplary aspect in which the solution artifact includes a service description (e.g., preamble) and interface descriptions, in accordance with an exemplary aspect of the present invention;

FIG. 4B illustrates an exemplary aspect in which a solution requirement may be matched with a solution asset in the business asset library, in accordance with an exemplary aspect of the present invention;

FIG. 5 illustrates an exemplary aspect in which common services (e.g., security and solution management) are supported in a model including the categories of adaptive entity (e.g., a state machine), flow, and adapter, in accordance with an exemplary aspect of the present invention;

FIG. 6A-6D illustrate some sample solution template schemas, in accordance with an exemplary aspect of the present invention;

FIG. 7 illustrates an example of a BPIM software solution stack 700, which may be utilized in accordance with an exemplary aspect of the present invention;

FIG. 8 illustrates possible tooling for the present invention which may include, for example, a Websphere® Studio Application Developer Integration Edition (WSADIE)/Eclipse Plugin-Solutio Composer (e.g., Version 1.0), in accordance with an exemplary aspect of the present invention;

FIG. 9 illustrates an inventive method 900 for generating a business process integration and management (BPIM) solution, in accordance with an exemplary aspect of the present invention;

FIG. 10 illustrates an example of hardware 1000 that may be used for generating a business process integration and management (BPIM) solution, in accordance with an exemplary aspect of the present invention; and

FIG. 11 illustrates a programmable storage medium 1100 which may tangibly embody a program of machine-readable instructions executable by a digital processing apparatus to perform the inventive method.

### DETAILED DESCRIPTION OF THE EMBODIMENTS OF THE INVENTION

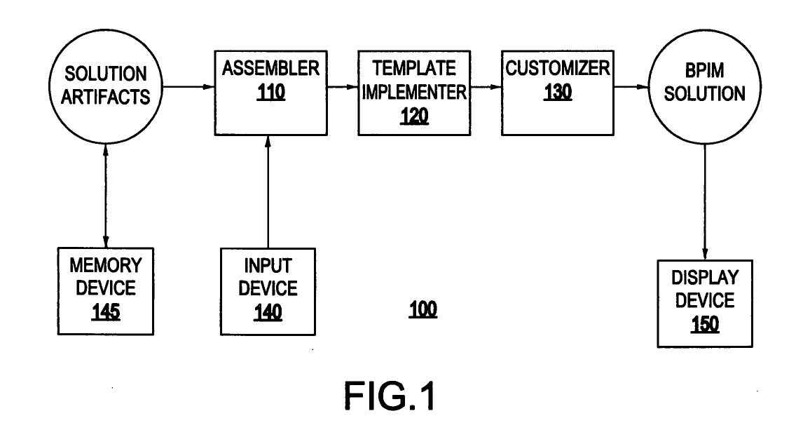

Referring now to the drawings, FIG. 1 illustrates an exemplary aspect of the present invention. Specifically, FIG. 1 illustrates an exemplary system 100 for generating a business process integration and management (BPIM) solution in accordance with an exemplary aspect of the present invention.

As shown in FIG. 1, the inventive system 100 includes an assembler 110 which assembles a plurality of solution artifacts to form a platform-independent solution template, a template implementer 120 which implements the platform-independent solution template to form a template implementation, and a customizer 130 which customizes the template implementation to generate a BPIM solution.

The system 100 may also include an input device 140 which may input, for example, a business process model, solution artifacts, etc., and a memory device 145 (e.g., random access memory (RAM), read only memory (ROM), etc.) which may be use to store, for example, software for performing a method of the present invention, and to store solution artifacts. That is, the memory device 145 may include a database which includes an asset library. The system may also include a display device 150 which may display, for example, a generated BPIM solution. Specifically, the input device 140 and display device 150 may be included as part of a graphical use interface (GUI) which may be used to implement the system 100.

Further, many of the elements of the system 100 (e.g., assembler 110, template implementer 120, and customizer 130) may be formed as one unit (e.g., a processor in a computer system) which may perform the functions of the respective elements. Alternatively, the elements may be separately formed and/or remotely located, and include a plurality of units (e.g., processors) which may be connected, as shown in FIG. 1.

The present invention provides a new and more efficient approach to developing and deploying of Business Process Integration and Management (BPIM) solutions. The platform-independent solution template approach in this invention will provide a systematic way of developing and deploying BPIM solutions, as well as reusing BPIM solution assets.

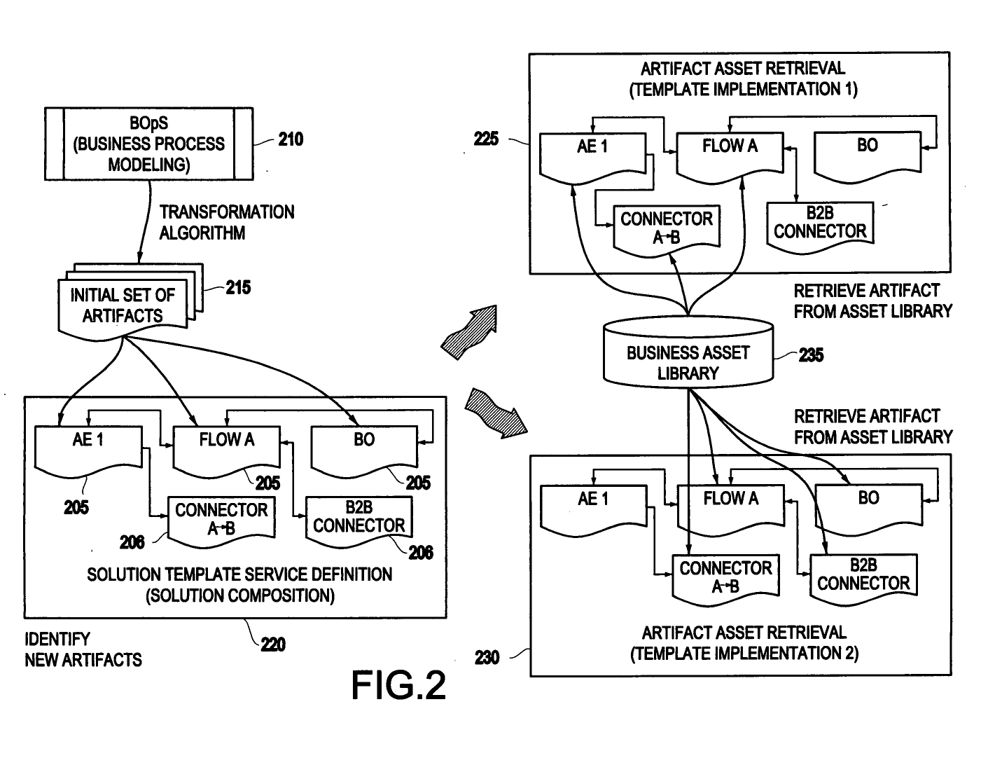

FIG. 2 illustrates a concept of an exemplary aspect of the present invention. Specifically, FIG. 2 illustrates a development from business process modeling to solution template creation.

As shown in FIG. 2, in this exemplary aspect, a business process model 210 may be transformed (e.g., using a transformation algorithm) into an initial set of artifacts 215. This set of artifacts 215 and/or new artifacts (e.g., identified in the business process model) may be used to form a solution template service definition 220 (e.g., solution composition). For example, in this exemplary aspect, solution composition 220 includes three artifacts 205 (e.g., an adaptive entity (AE 1), a Flow (e.g., Flow A), and a business object (BO)) from the initial set of artifacts 215, and two new artifacts 206 (e.g., a connector (connector A→B) and a business-to-business connector (B2B connector)).

Further, as shown in FIG. 2, the solution composition (e.g., solution template) may be implemented to form at least one template implementation (e.g., a plurality of template implementations). For example, the exemplary aspect illustrated in FIG. 2 includes template implementation 1 225, and template implementation 2 230. The template implemenation(s) may be developed by retrieving an artifact from a business asset library 235.

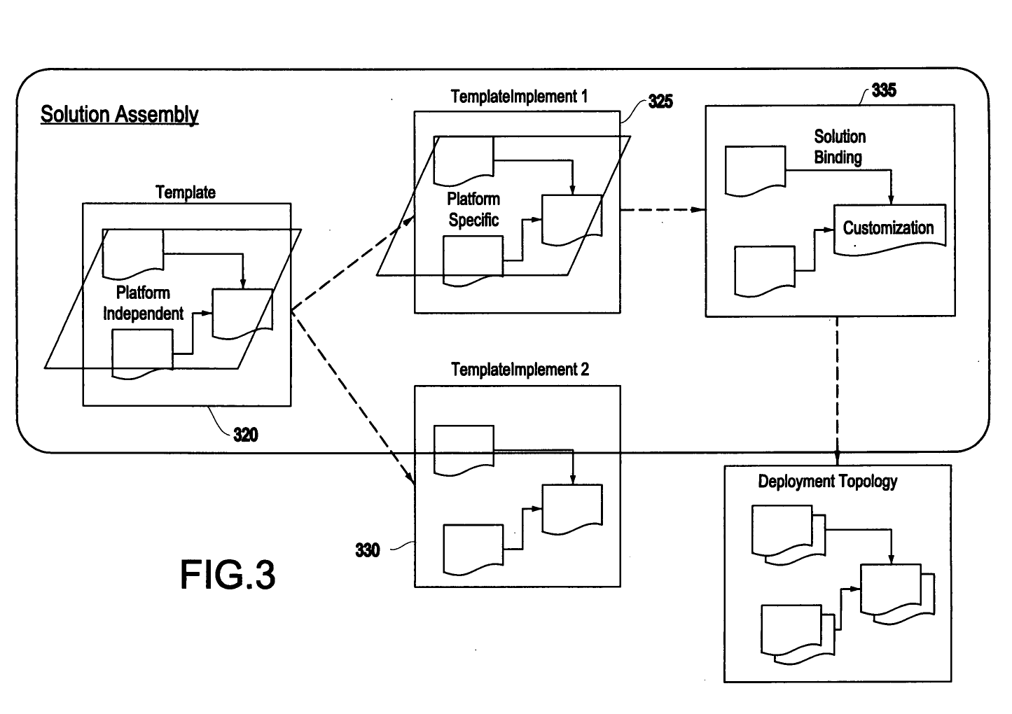

FIG. 3 illustrates a more detailed concept of an exemplary aspect of the present invention. Specifically, FIG. 3 illustrates a solution assembly (e.g., development from a solution template to a BPIM Solution).

As shown in FIG. 3, the solution template 320 (e.g., a platform-independent solution template) may be implemented to form a template implementation 325, 330 (e.g., a plurality of template implemenations). The template implementation may be customized to generate a BPIM solution 335. The BPIM solution 335 may be deployed.

For example, the BPIM solution 335 may include an e-business solution which is deployed using a computer network (e.g., the World Wide Web).

An exemplary feature of the invention includes a framework and its realization method of a decomposition of BPIM integration solutions into canonical solution artifacts with standard-based interfaces (e.g., Web Services). This framework permits flexible assembly and recomposition of these solution artifacts into solution templates. The abstract definition of solution templates will facilitate the further development and deployment of solution details. Furthermore, it supports the reusability of existing solution assets and improvements in the solution development and deployment effectiveness.

There are many advantages of the present invention. For example, the present invention provides systematic capturing of proven solutions. Further, the present invention deals with similar problems in a specific problem or solution domain. In addition, the present invention categorizes flexible, maintainable, extensible, scalable and sharable solution design patterns.

Generally speaking, the present invention may involve component decomposition/composition of BPIM solutions. In particular, the invention may include the scheme of decomposition of BPIM integration solutions into canonical solution artifacts. This decomposition scheme is a unique and exhaustive categorization of BPIM solutions. The invention may partition the BPIM solution space into modular and atomic components (e.g., categories), such as business object (BO) (e.g., a data object), Connector/Adapter/B2B Connector Adaptive Entity, Flow (Macroflow and Microflow), and View (Screenflow).

Further, the composition mechanism may include links between and within the artifacts to capture the interdependency among the solution artifacts. Specifically, the invention may use directLink (e.g., regular functional calls) and eventLink (e.g., event subscription and publication relationships).

Further, the present invention may utilize BPIM solution template definitions through models. In particular, the present invention supports a template approach to the BPIM solution composition. Further, it provides a mechanism for the description of the BPIM solution template for an abstract definition of a BPIM solution and its solution artifacts. Specifically, the present invention may utilize a solution template model, and a solution composition model.

The present invention further specifies methods and schemas to concretize the solution template by providing implementation and other development details. It also permits the extensions to the specification of deployment topology and scripts. Specifically, the present invention may utilize a template implementation model.

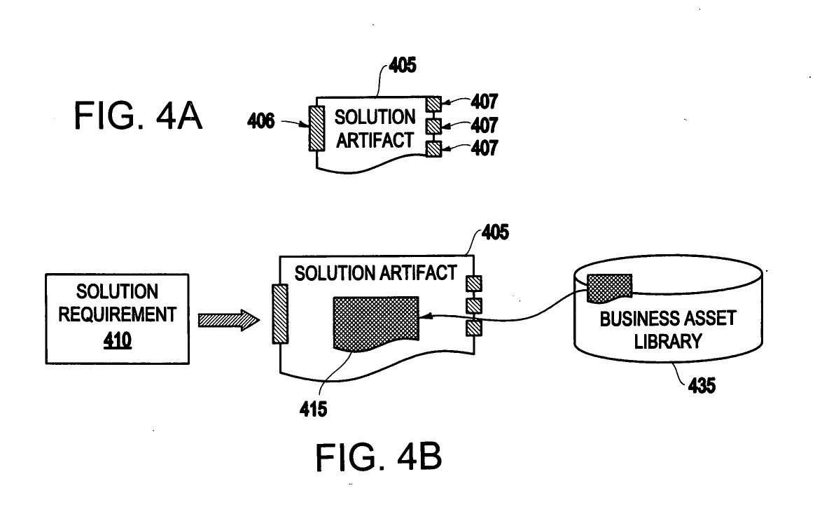

The present invention may further provide a mechanism to support BPIM solution and component reuse. The present invention may provide service containers (e.g., solution artifacts) for the individual components with full model and implementation details. For example, in the exemplary aspect of FIG. 4A, the solution artifact 405 includes a service description (e.g., preamble) 406, and interface descriptions 407. Further, as shown in FIG. 4B, the contents of these solution artifacts may change to match the solution requirements and reusability of existing assets. For example, as shown in FIG. 4B, a solution requirement 410 may be matched with a solution asset 415 in the business asset library 435. Further, the present invention provides the extensive referential links to facilitate asset reutilization.

The present invention further provides platform-independent web services descriptions. That is, the invention provides a platform-independent description using the Web services description standard for the interfaces of the artifacts. The separation of solution artifact service description and its implementation details permits the platform independence of the solution templates, and maintains the stability of solution templates.

Further, abstract solution artifact definition allows partially described solution templates to be captured. For example, the solution composition model for a partially defined solution template may contain solution artifacts whose definitions may include only a partial description of the interfaces or abstract artifact platform-independent models. This enables the identification of all participating solution artifacts in the solution template and their composition relationships regardless the availability of the detailed interface and model contents.

Further, realization of the framework may include a complete set of extensible markup language (XML) schemas and a prototype for the solution composition with invocation capability to invoke other component editors.

The present invention may further include common services definitions for solution artifacts. Specifically, the present invention may support a full description of a BPIM solution including both the content model and common services, such as security (e.g., access control), and solution management (e.g., logging, exception handling, etc.).

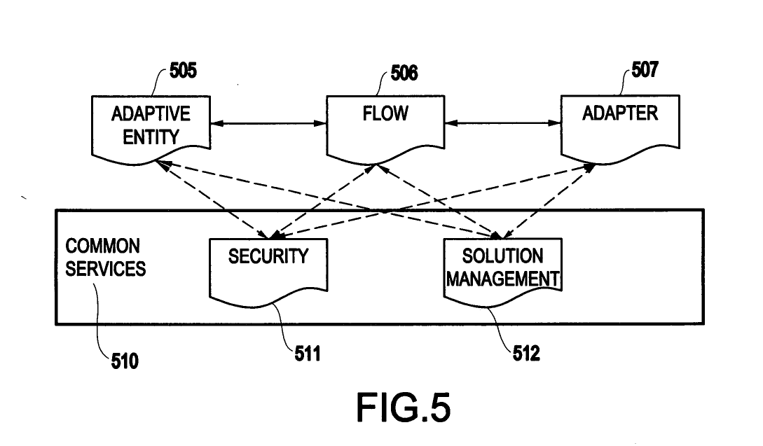

The present invention may further permit a common service probe to be placed at any level of the solution composition level and support a hierarchical inheritance model. For example, as shown in FIG. 5, common services 510 (e.g., security 511 and solution management 512) are supported in a model including the categories of adaptive entity 505 (e.g., a state machine), flow 506, and adapter 507.

Further, the present invention provides “end-to-end” support for BPIM solutions. That is, the present invention may provide direct support for the linkages to the underlying business process description. In addition, the present invention supports the description of solution artifacts and their composition resulting from a transformation from the corresponding business process models.

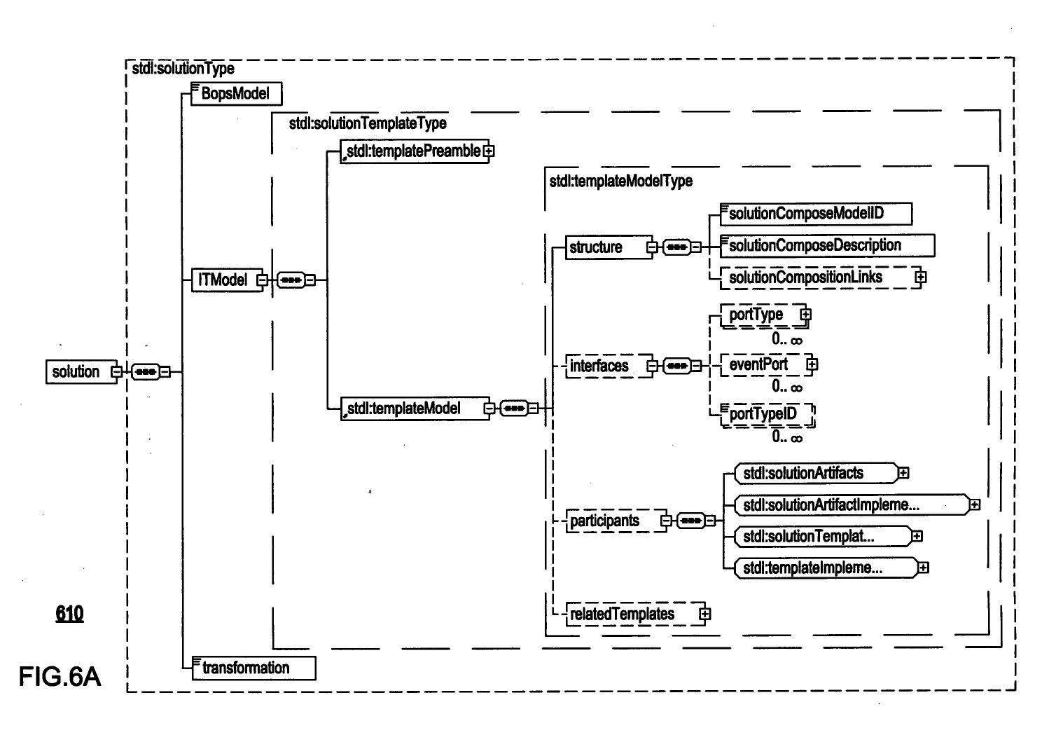

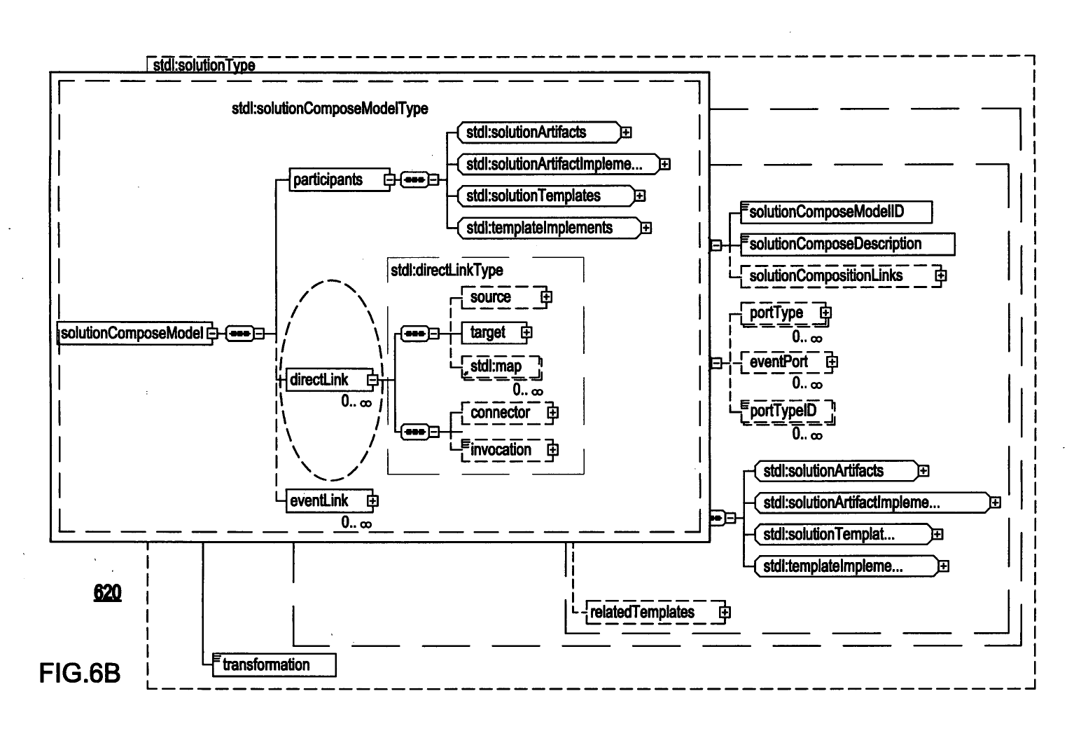

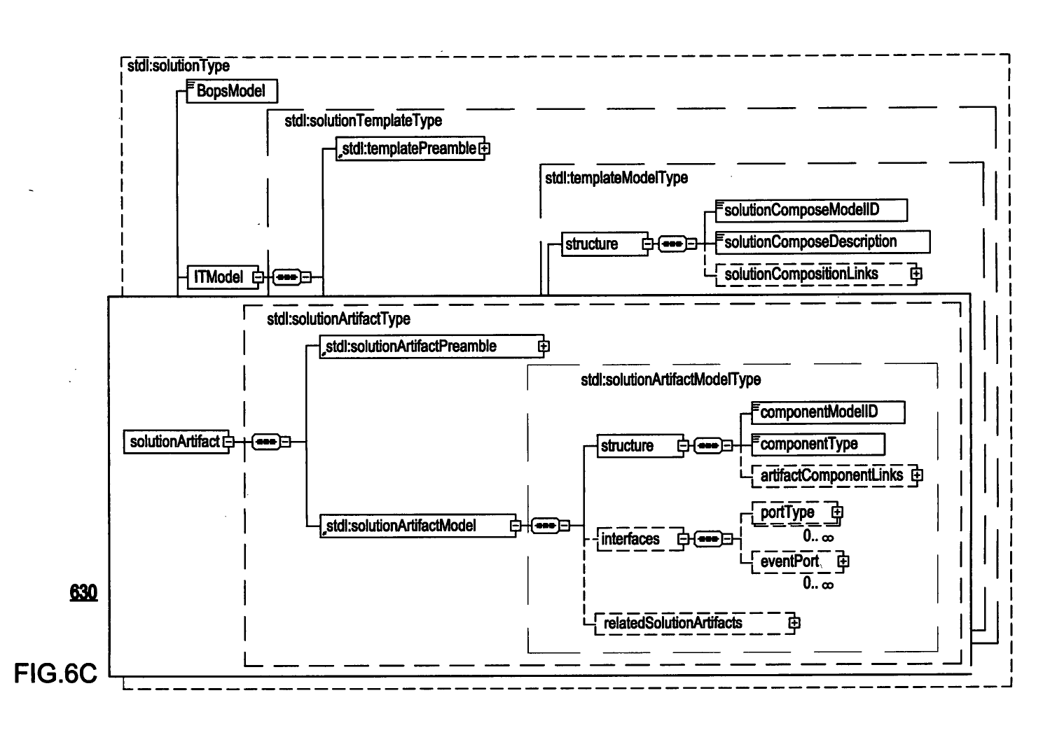

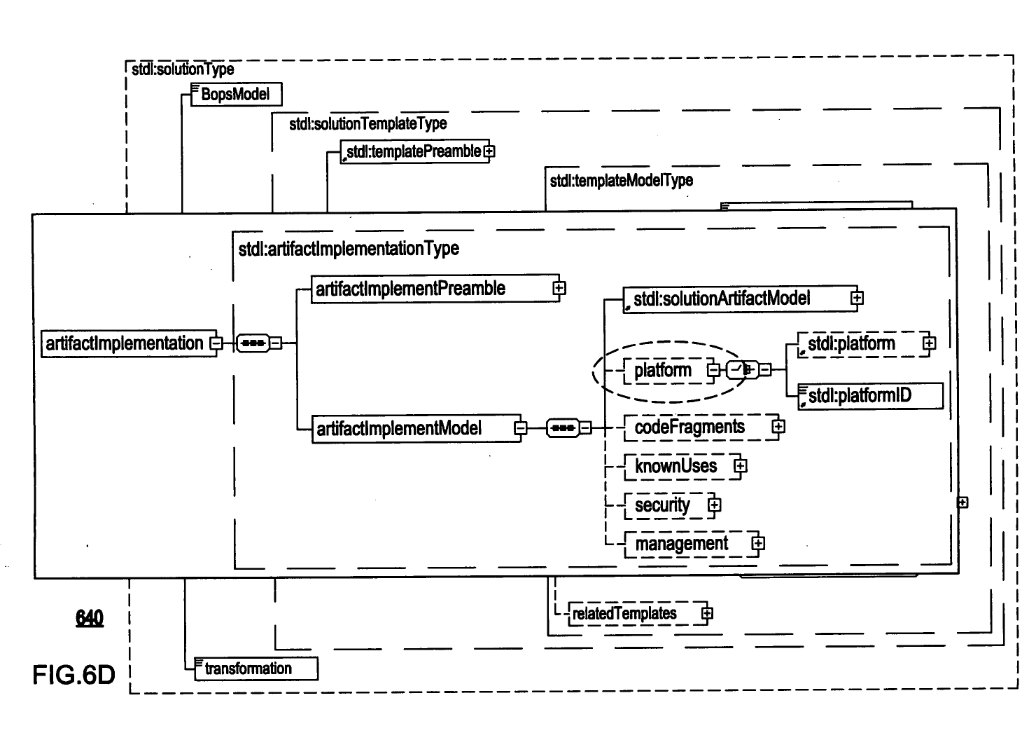

Referring again to the drawings, FIGS. 6A-6D illustrate some sample solution template schemas according to an exemplary aspect of the present invention. Specifically, FIG. 6A illustrates a general sample schema 610, FIG. 6B illustrates a compose model sample schema 620, FIG. 6C illustrates a solution artifact sample schema 630, FIG. 6D illustrates an artifact implementation sample schema 640.

The solution template approach of the present invention is completely unlike any conventional BPIM solution approach. For example, some conventional methods use components and component composite structures (e.g., unified modeling language (UML) (e.g., UML 2.0 which is to become an Object Management Group (OMG) standard) and Reusable Asset Specification (e.g., RAS, which seeks to become an OMG standard). These methods (e.g., UML and RAS) deal with general component reuse. However, these do not provide more complete models for the artifact and structural content of more complex BPIM solutions. In addition, these lack an end-to-end template-based BPIM solution creation support.

Other conventional methods utilize web services flow language (WSFL) (e.g., WSFL 1.0). Such methods deal with general web services flow and service composition. However, these methods do not involve more sophisticated models for BPIM solutions such as a state machine, views and event relationships. Further, these methods lack the support for common services such as security and solution management of the services.

The present invention has many other advantages over conventional systems and methods. For instance, the present invention supports a new generation of BPIM solution development. The invention also provides an information technology (IT) level metamodel for next generation BPIM tooling, and provides for efficient BPIM solution assembly based on templates.

In addition, the invention provides more efficient and manageable BPIM service engagements. That is, the present invention provides for fast and more structured solution development, and a reduced requirement for labor and skill.

Further, the present invention provides for BPIM solution asset reuse. Specifically, it provides support for the asset description for the solution artifacts and solution templates to be stored, searched and retrieved in a business asset library.

In addition, the solution template in the present invention has many uses. For example, it may be used for systematic capturing of proven solution assets to increase reusability. It also provides for a more efficient solution creation process through composition and assembly, and for flexible and adaptive BPIM solutions. Further, the solution template provides for pre-fabricated solutions/artifacts for faster assembly/deployment.

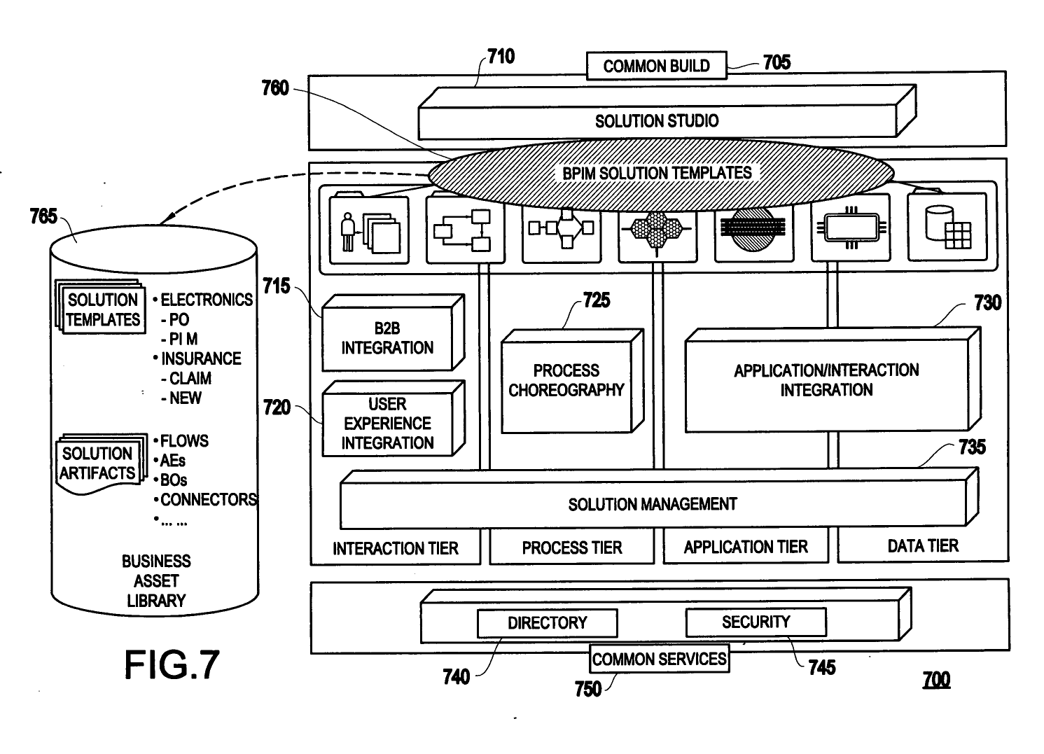

FIG. 7 illustrates a example of a BPIM software solution stack 700 which may be utilized in an exemplary aspect of the present invention. Specifically, the solution stack 700 includes a common build 705 and solution studio 710. Further, the solution stack 700 includes an interaction tier, process tier, application tier and data tier. For example, the interaction tier may include business-to-business (B2B) integration 715 and user experience integration 720, the process tier may include process choreography 725, and application and data tiers may include application/information integration 730. Further, solution management 735 may be included in all four tiers. In addition, the solution stack 700 includes a directory 740, security 745 and common services 750. Importantly, as shown in FIG. 7, solution stack 700 may include BPIM solution templates 760 which may be used to develop a business asset library 765.

The solution template may have many and divers applications. For example, the solution template may include a small/medium size business (e.g., global small/medium size business) solution template, an insurance industry solution template (e.g., proof of concept), a life sciences industry solution template (e.g., drug discovery process), a telecommunication industry solution template, and/or a personal computer manufacturing industry solution template.

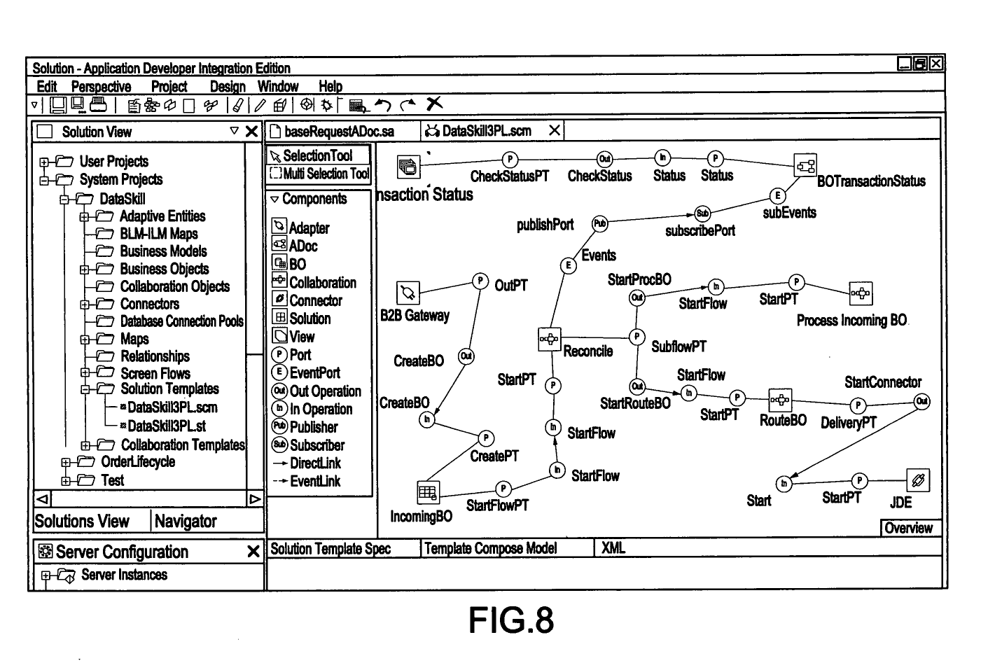

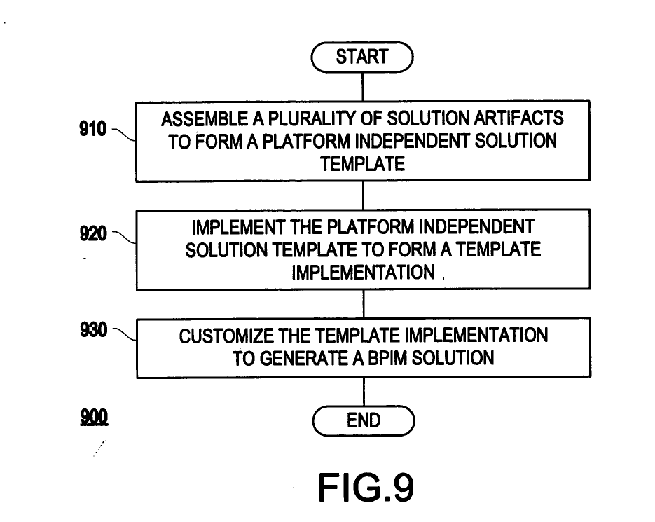

Further, in the present invention, a BPIM solution template may be implemented using an XML Schema (e.g., a specified XML schema for the solution template framework). The tooling for the present invention may include, for example, a WSADIE/Eclipse Plugin-Solutio Composer (e.g., Version 1.0), as illustrated, for example, in FIG. 8.

Further, the BPIM solution template may be implemented using a UML 2.0 Profile (e.g., create a UML profile for a BPIM solution template). In this case, the tooling may include, for example, WSADIE or Rational XDE.

Another aspect of the present invention includes an inventive method 900 for generating a business process integration and management (BPIM) solution. The inventive method 900 includes assembling (910) a plurality of solution artifacts to form a platform-independent solution template, implementing (920) the platform-independent solution template to form a template implementation, and customizing (930) the template implementation to generate a BPIM solution. For example, the inventive method 900 may be performed using the inventive system 100.

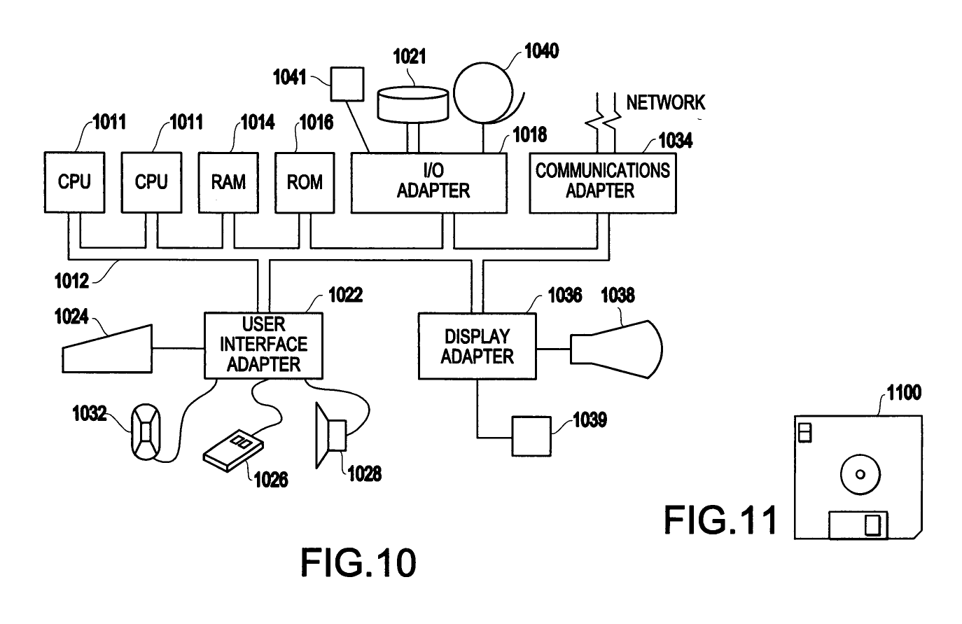

Referring now to FIG. 10, system 1000 illustrates a typical hardware configuration which may be used for implementing the inventive system and method for identifying a word correspondence. The configuration has preferably at least one processor or central processing unit (CPU) 1011. The CPUs 1011 are interconnected via a system bus 1012 to a random access memory (RAM) 1014, read-only memory (ROM) 1016, input/output (I/O) adapter 1018 (for connecting peripheral devices such as disk units 1021 and tape drives 1040 to the bus 1012), user interface adapter 1022 (for connecting a keyboard 1024, mouse 1026, speaker 1028, microphone 1032, and/or other user interface device to the bus 1012), a communication adapter 1034 for connecting an information handling system to a data processing network, the Internet, and Intranet, a personal area network (PAN), etc., and a display adapter 1036 for connecting the bus 1012 to a display device 1038 and/or printer 1039. Further, an automated reader/scanner 1041 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 1011 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 1011 and hardware above, to perform the method of the invention.

This signal-bearing media may include, for example, a RAM contained within the CPU 1011, as represented by the fast-access storage for example. Alternatively, the instructions may be contained in another signal-bearing media, such as a magnetic data storage diskette 1100 (e.g., as illustrated in FIG. 11), directly or indirectly accessible by the CPU 1011.

Whether contained in the computer server/CPU 1011, or elsewhere, the instructions may be stored on a variety of machine-readable data storage media, such as DASD storage (e.g, a conventional “hard drive” or a RAID array), magnetic tape, electronic re-only memory (e.g., ROM, EPROM, or EEPROM), an optical storage device (e.g., CD-ROM, WORM, DVD, digital optical tape, etc.), paper “punch” cards, or other suitable sign-bearing media including transmission media such as digital and analog and communication links and wireless. In an illustrative embodiment of the invention, the machine-readable instructions may include software object code, compiled from a language such as C, C+, etc.

With its unique and novel features, the present invention provides a system and method of generating a business process integration and management (BPIM) solution which is significantly more efficient than conventional systems and methods.

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

1. A system for generating a business process integration and management (BPIM) solution, comprising:
an assembler which assembles a plurality of solution artifacts to form a platform-independent solution template;
a template implementer which implements said platform-independent solution template to form a template implementation; and
a customizer which customizes said template implementation to generate a BPIM solution.

2. The system according to claim 1, wherein said assembler, said template implementer and said customizer are integrally formed and comprise a processor.

3. The system according to claim 1, further comprising:
a decomposer which decomposes a BPIM solution into said plurality of solution artifacts, a composition of said plurality of solution artifacts, and a specified set of associated common services.

4. The system according to claim 3, wherein said assembler categorizes said plurality of solution artifacts into categories comprising at least one of a business object category, connector/adapter/business-to-business connector category, adaptive entity category, flow category and view category.

5. The system according to claim 1, further comprising:
a memory device which stores said plurality of solution artifacts.

6. The system according to claim 5, wherein said plurality of solution artifacts are assembled from at least one of new solution artifacts and an initial set of artifacts identified in a business process model.

7. The system according to claim 1, further comprising:
a deployment apparatus for deploying said BPIM solution.

8. The system according to claim 7, wherein said deployment apparatus comprises a computer network.

9. The system according to claim 8, wherein said BPIM solution comprises an electronic commerce BPIM solution, and wherein said computer network comprises the world wide web.

10. The system according to claim 1, further comprising:
a business process modeler, operatively coupled to said assembler, which generates a business process model; and
an identifier which identifies an initial set of solution artifacts based on said business process model,
wherein said plurality of solution artifacts comprises said initial set of solution artifacts.

11. The system according to claim 1, wherein said platform-independent solution template comprises a plurality of platform-independent solution templates.

12. The system according to claim 11, further comprising:
a database operatively coupled to said assembler for storing said plurality of platform-independent solution templates.

13. The system according to claim 12, further comprising:
an input device operatively coupled to said template implementer, for inputting a business process model.

14. The system according to claim 13, wherein said template implementer maps at least one of said plurality of platform-independent solution templates with said business process model to form said template implementation.

15. The system according to claim 1, wherein a solution artifact in said plurality of solution artifacts comprises at least one interface description.

16. The system according to claim 1, wherein a solution artifact in said plurality of solution artifacts is alterable to match a BPIM solution requirement.

17. The system according to claim 1, wherein said platform-independent solution template comprises at least one of an extensible mark-up language (XML) schema, and a unified modeling language (UML) profile.

18. The system according to claim 1, wherein said platform-independent solution template comprises a modifiable and reusable template.

19. The system according to claim 1, wherein said template implementation comprises one of a small/medium size business solution template, an insurance industry solution template, a life sciences industry solution template, a telecommunication industry solution template, and a personal computer manufacturing industry solution template.

20. The system according to claim 1, wherein said plurality of solution artifacts comprises standard-based interfaces.

21. The system according to claim 1, wherein said template implementation comprises a platform-specific solution template.

22. A system for generating a business process integration and management (BPIM) solution, comprising:
assembling means which assembles a plurality of solution artifacts to form a platform-independent solution template;
template implementing means which implements said platform-independent solution template to form a template implementation; and
customizing means which customizes said template implementation to generate a BPIM solution.

23. A method for generating a business process integration and management (BPIM) solution, comprising:
assembling a plurality of solution artifacts with associated common services to form a platform-independent solution template;
implementing said platform-independent solution template to form a template implementation; and
customizing said template implementation to generate a BPIM solution.

24. The method according to claim 23, wherein said assembling said plurality of solution artifacts comprises at least one of retrieving artifacts from an asset library and creating new artifacts.

25. The method according to claim 23, further comprising:
modeling a business process to generate a business process model; and
identifying an initial set of solution artifacts based on said business process model, wherein said plurality of solution artifacts comprises said initial set of solution artifacts.

26. The method according to claim 23, further comprising:
decomposing a BPIM solution into a plurality of solution artifacts; and
storing said plurality of solution artifacts in a memory device.

27. The method according to claim 23, wherein said decomposing said BPIM solution comprises partitioning a BPIM solution space into components comprising at least one of a business object, connector/adapter/business-to-business connector, adaptive entity, flow and view.

28. The method according to claim 23, wherein said customizing said template implementation comprises modifying said solution artifact to conform to a requirement of said BPIM solution.

29. A programmable storage medium tangibly embodying a program of machine-readable instructions executable by a digital processing apparatus to perform a method for generating a business process integration and management (BPIM) solution, said method comprising:
assembling a plurality of solution artifacts and associated common services to form a platform-independent solution template;
implementing said platform-independent solution template to form a template implementation; and
customizing said template implementation to generate a BPIM solution.

30. A method for deploying computing infrastructure in which computer-readable code is integrated into a computing system, and combines with said computing system to perform a method for generating a business process integration and management (BPIM) solution, said method for generating a business process integration and management (BPIM) solution comprising:
assembling plurality of solution artifacts and associated common services to form a platform-independent solution template;
implementing said platform-independent solution template to form a template implementation; and
customizing said template implementation to generate a BPIM solution.
